(19) United States
(12) Patent Application Publication
(10) Pub. No.: US 2008/0102321 A1
(43) Pub. Date: May 1, 2008

(54) METHOD OF MANUFACTURING FERROELECTRIC THIN FILM FOR DATA STORAGE AND METHOD OF MANUFACTURING FERROELECTRIC RECORDING MEDIUM USING THE SAME METHOD

(75) Inventors: Simon BUEHLMANN, Yongin-si (KR); Seung-bum HONG, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/774,937

(22) Filed: Jul. 9, 2007

(30) Foreign Application Priority Data
Oct. 27, 2006 (KR) 10-2006-0105269

(51) Int. Cl. B05D 5/12; G11B 5/65

(52) U.S. Cl. 428/836.2; 427/126.3

(57) ABSTRACT

Provided are a ferroelectric thin film having good crystallinity, improved surface roughness, and high density data storage capability, and a method of manufacturing a ferroelectric recording medium including the ferroelectric thin film. The method of manufacturing the ferroelectric thin film includes: forming an amorphous TiO₂ layer on a substrate; forming a PbO(g) atmosphere on the amorphous TiO₂ layer; and reacting the TiO₂ layer with PbO(g) at a temperature of 400 to 650° C. to form a PbTiO₃ ferroelectric thin film having a nanograin structure of 1 to 20 nm on the substrate.

### CROSS-REFERENCE TO RELATED PATENT APPLICATION

This application claims the benefit of Korean Patent Application No. 10-2006-0105269, filed on Oct. 27, 2006, in the Korean Intellectual Property Office, the disclosure of which is incorporated herein in its entirety by reference.

### BACKGROUND OF THE INVENTION

1. Field of the Invention

The present invention relates to a method of manufacturing a ferroelectric thin film for data storage, and more particularly, to a method of manufacturing a ferroelectric thin film having a nanograin structure that achieves high density data storage, and a method of manufacturing a ferroelectric recording medium including the ferroelectric thin film.

2. Description of the Related Art

With the recent advances of data storage technology, the recording density of data storage devices, such as hard disks or optical disks, has increased to 1 Gbit/inch² or more. The rapid development of digital technology is requiring even higher capacity data storage devices. However, as for the conventional data storage devices, the maximum recording density is limited due to superparamagnetic limit or laser diffraction limit. Researches have recently been carried out into the development of data storage devices with a density over 100 Gbit/inch² which overcome the diffraction limit using near-field optics.

On the other hand, researches have been carried out into the development of high capacity data storage devices using tip-shaped probes as can be found in atomic force microscopy (AFM). Since tip-shaped probe can be downsized to several nanometers, atomic level surface microstructure can be observed using such tips. Theoretically, terabit data storage devices can be made using tip-shaped probe recording. Recording media and recording methods are important factors determining the performance of tip-shaped probe based data storage devices. Among the media, a ferroelectric recording medium stands out and thus has been subject to studies.

FIG. 1 is a cross-sectional view of a conventional ferroelectric recording medium.

Referring to FIG. 1, a bottom electrode 4 and a recording medium layer 8 are sequentially stacked on a substrate 2. The recording medium layer 8 is made of a ferroelectric thin film such as a PbTiO₃ thin film, a PbZrₓTi₍₁₋ₓ₎O₃ (PZT) thin film, or a SrBi₂Ta₂O₉ (SBT) thin film. When a voltage pulse is applied between the bottom electrode 4 and an AFM tip 9, the polarization of the ferroelectric medium can be locally changed. Depending on the sign of the voltage, up or down polarization can be written. The read-out of the polarization state can for example be detected using a resistive probe. For more information on the structure and operation of the ferroelectric recording medium, reference may be made to Korean Patent Publication No. 2001-0073306, the contents of which are incorporated herein by reference.

The recording medium using the ferroelectric thin film has advantage of high data writing speed, low power consumption, and the ability to rewriting data. Also, ferroelectric thin films deposited by conventional deposition techniques such as sputtering, CVD, MOCVD, and PLD are polycrystalline with an average grain size above typically 20 nm and have a poor surface roughness. Poor surface roughness lowers data reading and writing speeds and wears out the AFM tip 9. Since those problems of the conventional ferroelectric recording medium have already been of concern to researchers, attempts have been made to develop a ferroelectric thin film for high density data storage and a method of manufacturing the ferroelectric thin film, but they fell short so far because of manufacturing process limitations.

### SUMMARY OF THE INVENTION

The present invention provides a ferroelectric thin film having a uniform nanograin structure to improve crystallinity and surface roughness and to offer high density data storage capability, and a method of manufacturing a ferroelectric recording medium including the ferroelectric thin film.

According to an aspect of the present invention, there is provided a method of manufacturing a ferroelectric thin film, the method including: forming a substantially amorphous TiO₂ layer on a substrate; forming a PbO(g) atmosphere on the TiO₂ layer; and reacting the TiO₂ layer with PbO(g) at a temperature of 400 to 800° C. to form a PbTiO₃ ferroelectric thin film on the substrate. In one embodiment, the PbTiO₃ ferroelectric thin film has a nanograin structure of 1 to 20 nm.

According to another aspect of the present invention, there is provided a method of manufacturing a ferroelectric recording medium, the method including: forming an electrode layer made of a conductive material on a substrate; forming a substantially amorphous TiO₂ layer on the electrode layer; forming a PbO(g) atmosphere on the TiO₂ layer; and reacting the TiO₂ layer with PbO(g) at a temperature of 400 to 800° C. to form a PbTiO₃ ferroelectric thin film on the electrode layer. In one embodiment, the PbTiO₃ ferroelectric thin film has a nanograin structure of 1 to 20 nm.

The grain size and the stoichiometry of the PbTiO₃ ferroelectric thin film may be controlled by controlling at least one of the parameters such as the temperature, reaction time and PbO flux towards the TiO₂ layer.

The reaction time between the TiO₂ layer and the PbO(g) may be controlled to range from 1 second to 60 minutes.

The amorphous TiO₂ layer may be formed at a temperature of 10 to 650° C. In one embodiment, it is formed at a temperature of below 400° C. The amorphous TiO₂ layer may be formed to a thickness of 1 to 100 nm.

Accordingly, a ferroelectric thin film having a nanocrystalline structure and improved surface roughness and high density data storage capability, and a ferroelectric recording medium including the ferroelectric thin film can be obtained.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional ferroelectric recording medium;

FIGS. 2A through 2C are cross-sectional views illustrating a method of manufacturing a ferroelectric thin film according to an embodiment of the present invention;

FIG. 3A is a scanning electron microscopy (SEM) photograph illustrating a smooth surface of an amorphous TiO₂ layer deposited at a temperature of approximately 400° C. in a ferroelectric thin film manufacturing process according to the present invention;

FIG. 3B is an SEM photograph illustrating a rough surface of an crystalline TiO₂ layer deposited at a temperature above about 650° C. in a conventional ferroelectric thin film manufacturing process;

FIG. 4A is an SEM photograph illustrating a smooth surface of a PbTiO₃ ferroelectric thin film formed by reacting the amorphous TiO₂ layer with PbO(g) at a temperature of approximately 600° C. in the manufacturing process according to the present invention;

FIG. 4B is an SEM photograph illustrating a rough surface of a PbTiO₃ ferroelectric thin film formed by reacting the TiO₂ layer with PbO(g) at a temperature above approximately 650° C. in the conventional manufacturing process;

FIG. 5A illustrates uniform nucleation and nanograin growth in the PbTO₃ ferroelectric thin film manufacturing process according to the present invention;

FIG. 5B illustrates nonuniform nucleation and grain growth in the conventional PbTO₃ ferroelectric thin film manufacturing process;

FIG. 6A is an X-ray diffraction (XRD) analysis graph of a PbTiO₃ ferroelectric thin film manufactured by a method according to the present invention;

FIG. 6B is an XRD analysis graph of TiO₂ after single crystalline TiO₂ is reacted with PbO;

FIG. 7 is a transmission electron microscope (TEM) photograph illustrating nanograins of the PbTiO₃ ferroelectric thin film manufactured by the method according to the present invention; and

FIGS. 8A through 8D are cross-sectional views illustrating a method of manufacturing a ferroelectric recording medium according to an embodiment of the present invention.

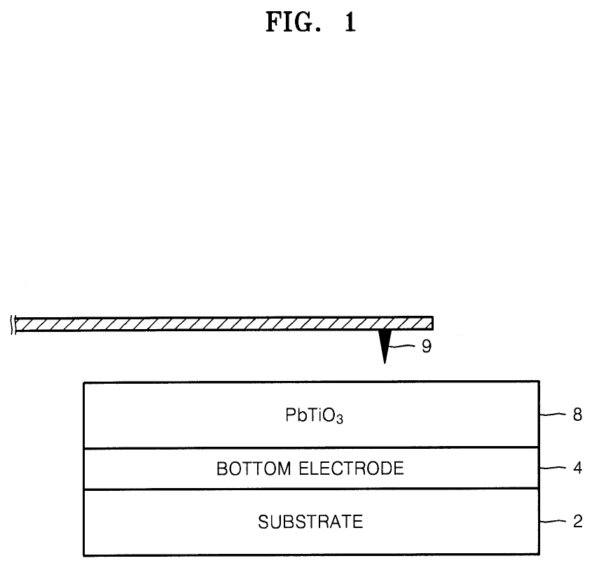

### DETAILED DESCRIPTION OF THE INVENTION

The present invention will now be described more fully with reference to the accompanying drawings, in which exemplary embodiments of the invention are shown. The thicknesses of layers or regions in the drawings are exaggerated for clarity.

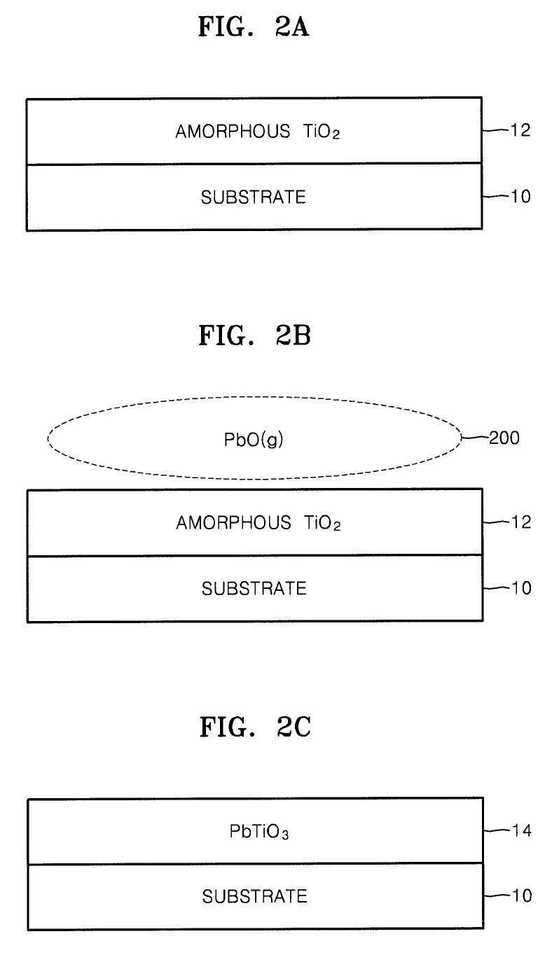

FIGS. 2A through 2C are cross-sectional views illustrating a method of manufacturing a ferroelectric thin film according to an embodiment of the present invention.

Referring to FIG. 2A, an amorphous TiO₂ layer 12 is formed on a substrate 10. The substrate 10 may be quartz or SiO₂ based glass substrate, an MgO single crystal substrate, a silicon single crystal substrate, or other substrate.

The substantially amorphous TiO₂ layer 12 may be formed by one of various known methods, which include, but are not limited to, sputtering, thermal evaporation, chemical vapor deposition (CVD), metalorganic chemical vapor deposition (MOCVD), and atomic layer deposition (ALD). The TiO₂ layer 12 may be formed at a temperature of 10 to 650° C. In one embodiment, the TiO₂ layer 12 is formed at a temperature of 10 to 400° C. The formation of crystalline TiO₂ grains are effectively prevented at a temperature up to 400 ° C. and the TiO₂ layer 12 deposited at a temperature below 400° C. have a smooth surface. This allows manufacturing a PbTiO₃ ferroelectric thin film with a smooth surface in a subsequent process where the TiO₂ layer 12 is used as a precursor. Even though crystalline TiO₂ starts to appear at a temperature above 400° C. and up to 650° C., the degree of the crystalline TiO₂ grain formation is acceptable. On the contrary, when the amorphous TiO₂ layer 12 is formed at a high temperature above 650° C., the TiO₂ layer 12 starts to have a rough surface and a number of crystalline TiO₂ grains are generated. The crystalline TiO₂ grains may deteriorate the properties of a PbTiO₃ thin film that is to be formed later. In the present application, the term “substantially amorphous” indicates that TiO₂ layer may contain a small portion of crystalline TiO₂ grains as long as they do not deteriorate the properties of the PbTiO₃ thin film formed by the reaction of the TiO₂ layer and the PbO(g).

Since the surface roughness of the amorphous TiO₂ layer 12 directly affects the surface finish of the PbTiO₃ thin film, it is important that the TiO₂ layer 12 is formed to have a smooth surface.

Preferably, the amorphous TiO₂ layer 12 may be formed to a thickness of 1 to 100 nm. This thickness range is effective for uniform nucleation and nanograin growth in the subsequent process of forming the PbTiO₃ ferroelectric thin film. For example, if the amorphous TiO₂ layer 12 is thicker than 100 nm, it may be difficult to guarantee uniform nucleation and nanograin growth in forming the PbTiO₃ ferroelectric thin film.

Referring to FIGS. 2B and 2C, a PbO(g) atmosphere 200 is formed on the amorphous TiO₂ layer 12. The PbO(g) atmosphere 200 may be formed by thermal evaporation or sputtering. For example, PbO(g) may be obtained by thermally evaporating PbO powder. Alternatively, PbO(g) may be easily obtained by installing a Pb target or a PbO target in a sputtering chamber and sputtering the same in a plasma atmosphere containing oxygen (O₂).

Next, the amorphous TiO₂ layer 12 and the PbO(g) are allowed to react with each other at a temperature of 400 to 800° C. to form a PbTiO₃ ferroelectric thin film 14 having a nanograin structure of 1 to 20 nm on the substrate 10. In detail, the TiO₂ layer 12 is transformed into the PbTiO₃ ferroelectric thin film 14 by annealing the TiO₂ layer 12 in the PbO(g) atmosphere 200. Here, the grain size of the PbTiO₃ ferroelectric thin film 14 can be controlled by controlling at least one of the temperature, reaction time and PbO flux towards the TiO₂ layer.

In conventional deposition processes, grain sizes of typically above 20 nm are formed. This is because theses processes are governed by a mechanism of nucleation from gas phase, adsorption on the surface and growth. In this invention, the precursor layer (TiO₂) is already solid. Instead of a gas to solid transition, a solid (TiO₂) is transformed to other solid (PbTiO₃) by gas phase reaction. This process is fast and characterized by a high nucleation rate, which assures nanograin formation.

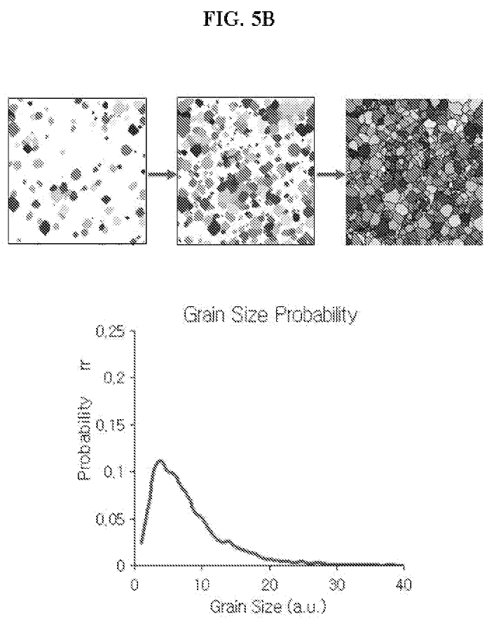

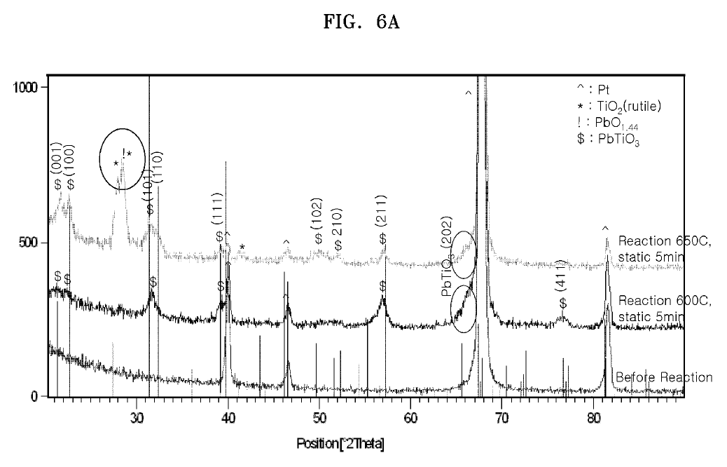

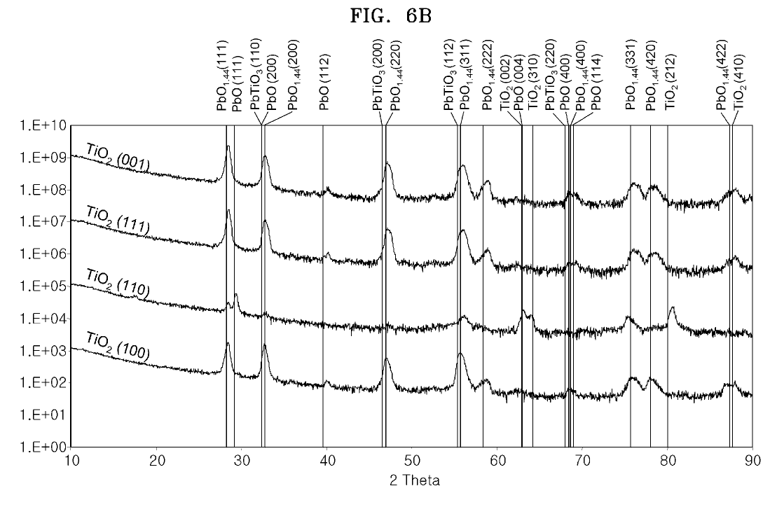

The temperature range of 400 to 800° C. is closely related with uniform nucleation and nanograin growth. For example, when the amorphous TiO₂ layer 12 and the PbO(g) are forced to react with each other at the low temperature of 400 to 650° C., a greater number of nuclei are generated and grown to small grains whose size distribution is narrow (see FIG. 5A). However, when the amorphous TiO₂ layer 12 and the PbO(g) are forced to react with each other at a high temperature above 650° C., a smaller number of nuclei are generated and grown to large grains whose size distribution is broad (see FIG. 5B). Moreover, at higher temperatures above 650° C., the amorphous TiO₂ layer starts to transform into crystalline TiO₂. This can be prevented by choosing very short reaction times. The effect of crystalline TiO₂ formation is shown in FIG. 6B. In FIG. 6B, single crystalline TiO₂ has been reacted with PbO at 600° C. FIG. 6B shows an x-ray after PbO reaction. It is seen that large amounts of unwanted PbO_{1.44} are present in the final film. In addition to the reaction temperature, a reaction time greatly affects uniform nucleation and nanograin growth. For example, when the reaction time is short, since grains do not have sufficient time to grow, the PbTiO₃ ferroelectric thin film 14 may have a nanograin structure. However, when the reaction time is long, grains have sufficient time to grow and the PbTiO₃ ferroelectric thin film 14 may have a relatively large grain structure. Accordingly, in order to form the PbTiO₃ ferroelectric thin film 14 having a nanograin structure, the amorphous TiO₂ layer 12 and the PbO(g) are allowed to react with each other for a short time at a temperature of preferably 400 to 650° C. Preferably, the reaction time between the TiO₂ layer 12 and the PbO(g) may be controlled to range from 1 second to 60 minutes. Since the reaction time is related with the reaction temperature as described above, the reaction time can be properly selected according to the reaction temperature.

The processing parameters PbO flux and reaction temperature have to be chosen such as to prevent the deposition of solid PbO. PbO deposition is favoured at lower temperatures because at the lower temperature, the PbO re-evaporation is decreased. PbO deposition is favoured at higher PbO fluxes, when the incoming flux of PbO is greater than the re-evaporation of PbO. Alternatively, a pulsed reaction can be chosen, where a PbO flux applied during one cycle and no or less PbO flux is applied during the next cycle to assure re-evaporation of PbO. This can for example be realized by switching on and off the power on the Pb or PbO target or by rotating the substrate below the Pb/PbO target where the sample experiences PbO flux only whenever it faces the PbO target and not elsewhere.

Depending on the reaction condition, the PbO flux may be in the range of 0.5 to 30 nm/min. In order to fully react a TiO₂ film, a certain amount of PbO is used. For example, it is calculated that in order to react 1 nm of TiO₂, PbO of 1.3 nm is required. In an exemplary embodiment, a 3 nm thick amorphous TiO₂ layer was fully reacted to PbTiO₃ at 600° C. with a PbO flux of 10 nm/min for 30 seconds. The amount of PbO used in that case was 3.9 nm. The excess amount of PbO of 1.1 nm quickly re-evaporated at 600° C. In another exemplary example, the TiO₂ was 5 nm thick, the reaction temperature was 500° C., and the PbO flux was 10 nm/min. In this case, as the temperature is much lower than 600° C., PbO re-evaporation was greatly decreased, but still occurred. Therefore, the reaction was performed in a pulsed manner by rotating the sample through the PbO reaction zone during 13 min. The rotation speed was 7 rpm (8.5 s per turn). At each turn, the sample rotated through the PbO reaction zone for 1 second, which produced an effective PbO flux of 1.2 nm/min. During the rest of the turn (7.5 s), excessive PbO was allowed to re-evaporate from the sample surface. The total time of reaction was 1.5 min for 15 nm PbO. The excess PbO of 10 nm was re-evaporated during such pulsed operation.

A ferroelectric thin film having a nanograin structure of 5 nm or less is difficult to be manufactured in a conventional process. However, a ferroelectric thin film having a uniform nanograin structure of 5 nm or less can be easily manufactured in the process according to the present invention. When a recording medium for data storage is manufactured using the ferroelectric thin film having the nanograin structure, the recording medium can ensure higher capacity data storage than its conventional counterpart.

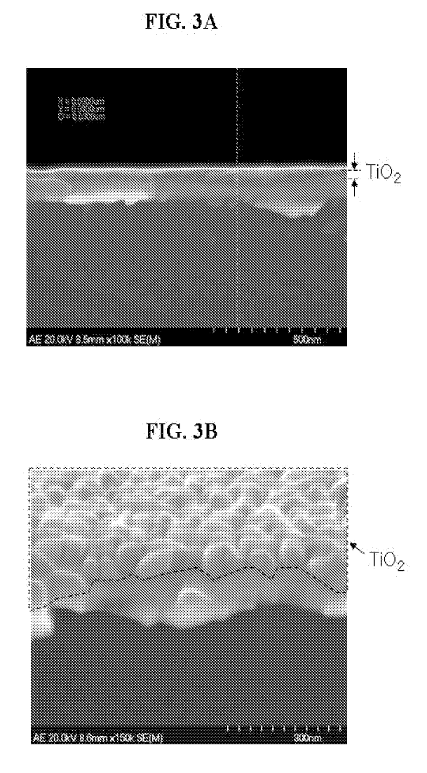

FIG. 3A is a scanning electron microscopy (SEM) photograph illustrating a smooth surface of an amorphous TiO₂ layer deposited by sputtering at a temperature of approximately 400° C. in a ferroelectric thin film manufacturing process according to the current embodiment of the present invention. FIG. 3B is an SEM photograph illustrating a rough surface of a crystalline TiO₂ layer deposited at a temperature above approximately 650° C. using the same sputtering conditions as in FIG. 3A. When compared, the amorphous TiO₂ layer deposited at the low temperature below about 650° C. in the process according to the present invention has a smoother surface than the amorphous TiO₂ layer deposited at the high temperature above about 650° C. in the conventional process.

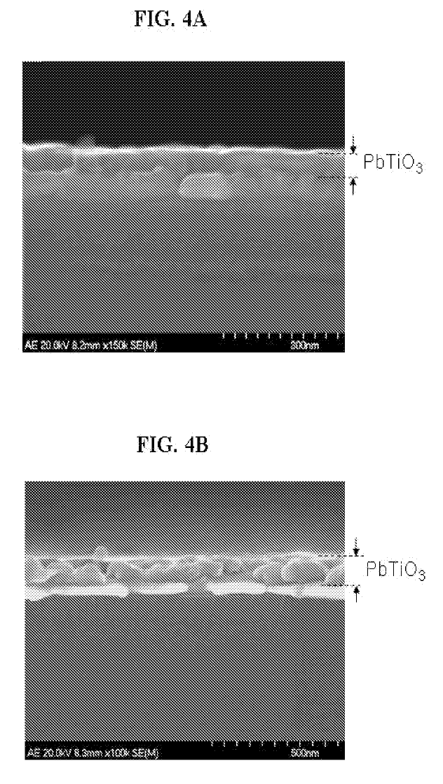

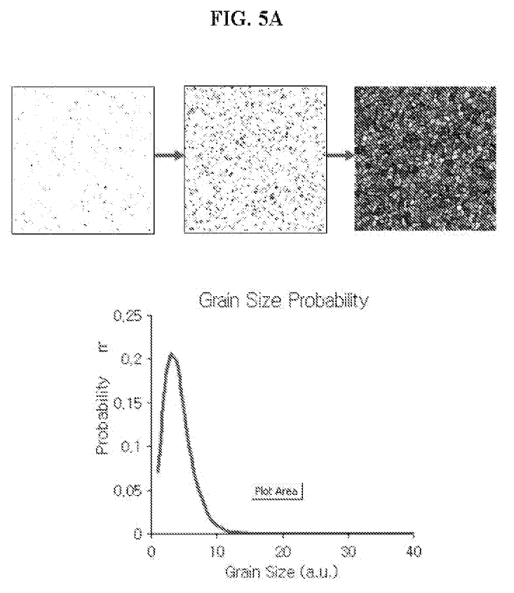

FIG. 4A is an SEM photograph illustrating a smooth surface of a PbTO₃ ferroelectric thin film deposited by reacting the amorphous TiO₂ layer of FIG. 3A with PbO(g) at a temperature of approximately 600° C. in the manufacturing process according to the present invention. FIG. 4B is an SEM photograph illustrating a rough surface of a PbTO₃ ferroelectric thin film formed by reacting the TiO₂ layer of FIG. 3A with PbO(g) at a temperature above about 650° C. When compared, the PbTO₃ ferroelectric thin film formed at the lower PbO reaction temperature in the manufacturing process according to the present invention has a smoother surface than the PbTO₃ ferroelectric thin film formed at the high temperature above about 650° C.

FIG. 5A illustrates high nucleation density and nanograin formation in the PbTO₃ ferroelectric thin film manufacturing process according to the present invention. FIG. 5B illustrates low nucleation rate and grain growth in the conventional PbTO₃ ferroelectric thin film manufacturing process.

FIG. 6A is an X-ray diffraction (XRD) analysis graph of a PbTO₃ ferroelectric thin film manufactured by a method according to the present invention. FIG. 6B is an XRD analysis graph of a PbTO₃ ferroelectric thin film manufactured by a method according to the present invention but using single crystalline TiO₂ wafers. When compared, the PbTO₃ ferroelectric thin film (see FIG. 6B) manufactured using single crystalline TiO₂ contains additional phases of PbO_{1.44} and crystalline TiO₂, and the amount of PbTiO₃ is very small. The PbTO₃ ferroelectric thin film manufactured from an amorphous TiO₂ layer (see FIG. 6A) and reacted at about 600° C. only contains PbTiO₃ phases. The PbTO₃ ferroelectric thin film manufactured from an amorphous TiO₂ layer (see FIG. 6A) and reacted above about 650° C. shows the appearance of crystalline TiO₂ and PbO_{1.44} phases. In FIG. 6A, TiO₂ peaks are detected before the reaction, because the TiO₂ is amorphous. Referring to FIG. 6A, peaks appear at platinum (Pt) because the PbTO₃ ferroelectric thin film was formed on a platinum (Pt) electrode layer and then was used as a data analysis sample.

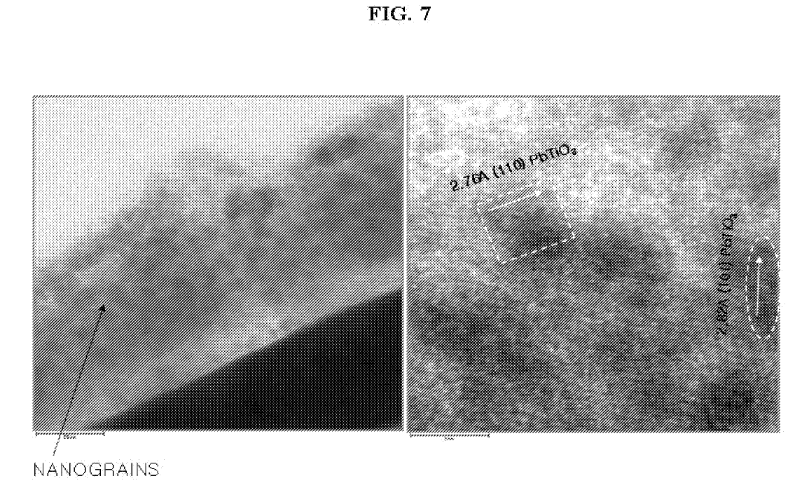

FIG. 7 is a transmission electron microscope (TEM) photograph illustrating nanograins of the PbTiO₃ ferroelectric thin film manufactured by the method according to the present invention.

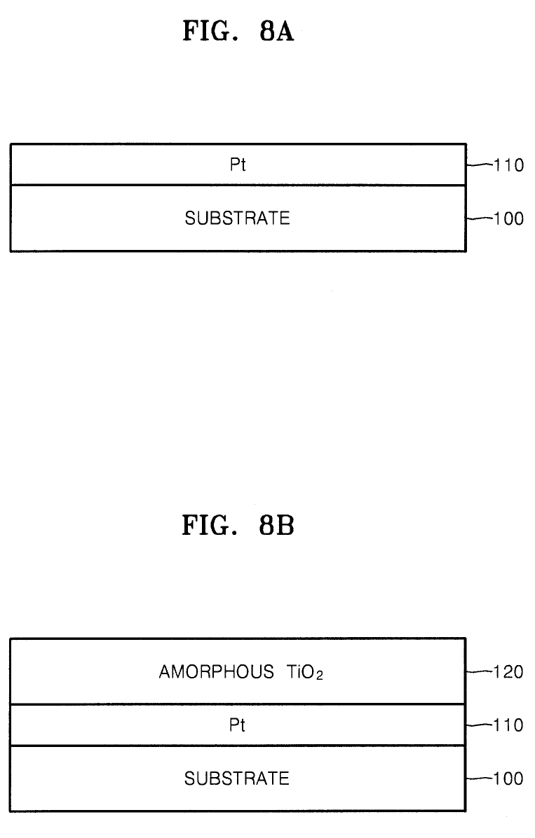

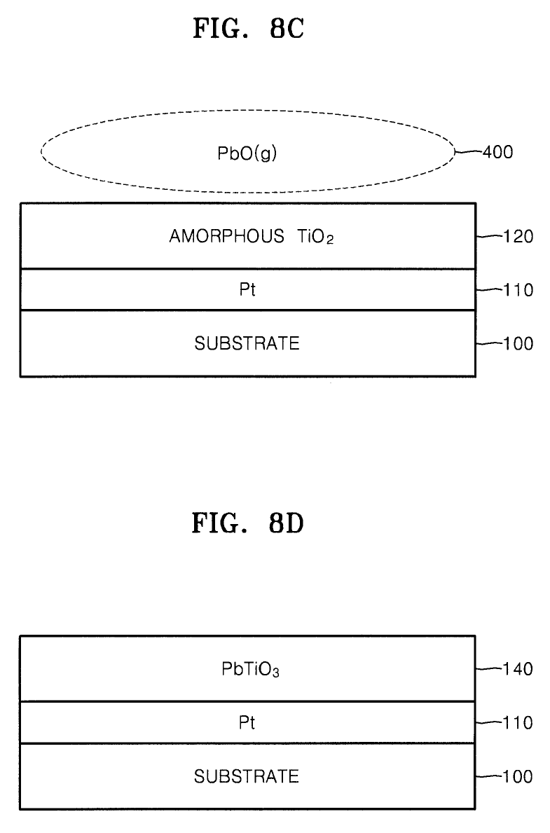

FIGS. 8A through 8D are cross-sectional views illustrating a method of manufacturing a ferroelectric recording medium according to an embodiment of the present invention. Since a process of manufacturing a ferroelectric thin film in the ferroelectric recording medium manufacturing method has already been explained above, an explanation thereof will not be given.

Referring to FIGS. 8A and 8B, an electrode layer 110 made of a conductive material, such as platinum (Pt) or iridium (Ir), is formed on a substrate 100. The electrode layer 110 may be formed by various vapor depositions such as sputtering, MOCVD, and MOCVD. Next, an amorphous TiO₂ layer 120 is formed on the electrode layer 110. The substrate 100 may be quartz or SiO₂ based glass substrate, an MgO single crystal substrate, a silicon single crystal substrate, or other substrate.

The amorphous TiO₂ layer 120 may be formed by one selected from the group consisting of sputtering, thermal evaporation, CVD, MOCVD, and ALD. Here, the TiO₂ layer 120 may be formed at a temperature of 10 to 650° C., preferably at a temperature of 10 to 400° C. Preferably, the amorphous TiO₂ layer 120 may be formed to a thickness of 1 to 100 nm. The thickness of this range may be effective for uniform nucleation and nanograin growth in a subsequent process of manufacturing a PbTiO₃ ferroelectric thin film. For example, when the TiO₂ layer 120 is thicker than 100 nm, it may be difficult to guarantee uniform nucleation and nanograin growth in forming the PbTiO₃ ferroelectric thin film.

Referring to FIGS. 8C and 8D, a PbO(g) atmosphere 400 is formed on the amorphous TiO₂ layer 120. The PbO(g) atmosphere 400 may be formed by thermal evaporation or sputtering. For example, PbO(g) may be obtained by thermally evaporating PbO powder. Alternatively, PbO(g) may be easily obtained by installing a Pb target or a PbO target in a sputtering chamber and sputtering the same in a plasma atmosphere containing oxygen (O₂).

Next, the amorphous TiO₂ layer 120 and the PbO(g) are allowed to react with each other at a temperature of 400 to 800°c. to form a PbTiO₃ ferroelectric thin film 140 having a nanograin structure of 1 to 20 nm on the electrode layer 11O. In detail, the TiO₂ layer 120 is transformed into the PbTiO₃ ferroelectric thin film 140 by annealing the TiO₂ layer 120 in the PbO atmosphere 400. The grain size of the PbTiO₃ ferroelectric thin film 140 can be controlled by controlling at least one of the temperature and reaction time between the TiO₂ layer 120 and the PbO(g) as described above.

In order to form the PbTiO₃ ferroelectric thin film 140 having a nanograin structure, the amorphous TiO₂ layer 120 and the PbO(g) may be forced to react with each other for a short time at a temperature of 400 to 800° C. Preferably, the reaction time between the TiO₂ layer 120 and the PbO(g) may be controlled to range from 1 second to 60 minutes. Since the reaction time, temperature and PbO flux are related with each other as described above, the reaction time may be properly selected according to the reaction temperature.

The grain size of the PbTiO₃ ferroelectric thin film 140 may range from 1 to 5 nm. As the grain size decreases, the PbTiO₃ ferroelectric thin film 140 can provide higher density data storage than its conventional counterpart, and the crystallinity and surface roughness of the PbTiO₃ ferroelectric thin film 140 can be improved due to the nanograin structure. Furthermore, the ferroelectric recording medium including the ferroelectric thin film having the nanograin structure can ensure higher capacity data storage than its conventional counterpart.

Accordingly, a ferroelectric thin film having a nanocrystalline structure and improved surface roughness and high density data storage capability, and a ferroelectric recording medium including the ferroelectric thin film can be obtained.

In detail, according to the manufacturing process of the present invention, a ferroelectric thin film having a uniform nanograin structure of 5 nm or less can be obtained. When a recording medium for data storage is manufactured using the ferroelectric thin film having the nanograin structure, the recording medium can ensure higher capacity data storage than its conventional counterpart. Accordingly, a data storage device with a high density over 100 Gbit/inch² can be easily realized. In addition to the improved surface roughness, the ferroelectric thin film according to the present invention can be manufactured, thereby lowering manufacturing cost and time.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a ferroelectric thin film, the method comprising:
forming a substantially amorphous TiO₂ layer on a substrate;
forming a PbO(g) atmosphere on the TiO₂ layer; and
reacting the TiO₂ layer with PbO(g) at a temperature of 400 to 800° C. to form a PbTiO₃ ferroelectric thin film on the substrate.

2. The method of claim 1, wherein the PbTiO₃ ferroelectric thin film has a nanograin structure of 1 to 20 nm.

3. The method of claim 1, wherein the grain size and the stoichiometry of the PbTiO₃ ferroelectric thin film is controlled by controlling at least one of PbO flux towards the TiO₂ layer, the temperature and reaction time between the TiO₂ layer and the PbO(g).

4. The method of claim 3, wherein the reaction time between the TiO₂ layer and the PbO(g) is in the range from 1 second to 60 minutes.

5. The method of claim 3, wherein the grain size of the PbTiO₃ ferroelectric thin film ranges from 1 to 5 nm.

6. The method of claim 1, wherein the TiO₂ layer is formed at a temperature of 10 to 650° C.

7. The method of claim 6, wherein the TiO₂ layer is formed at a temperature of 10 to 400° C.

8. The method of claim 1, wherein the TiO₂ layer is formed to a thickness of 1 to 100 nm.

9. The method of claim 1, wherein the forming of the TiO₂ layer is carried out by sputtering, thermal evaporation, chemical vapor deposition, metal organic chemical vapor deposition, or atomic layer deposition.

10. The method of claim 1, wherein the PbO(g) atmosphere is formed by thermal evaporation or sputtering.

11. The method of claim 1, wherein the PbO(g) atmosphere is formed by sputtering a Pb target in an oxygen (O₂) atmosphere.

12. A method of manufacturing a ferroelectric recording medium, the method comprising:
forming an electrode layer made of a conductive material on a substrate;
forming a substantially amorphous TiO₂ layer on the electrode layer;
forming a PbO(g) atmosphere on the TiO₂ layer; and
reacting the TiO₂ layer with PbO(g) at a temperature of 400 to 800° C. to form a PbTiO₃ ferroelectric thin film on the electrode layer.

13. The method of claim 12, wherein the PbTiO₃ ferroelectric thin film has a nanograin structure of 1 to 20 nm.

14. The method of claim 12, wherein the grain size and the stoichiometry of the PbTiO₃ ferroelectric thin film is controlled by controlling at least one of PbO flux towards the TiO₂ layer, the temperature and reaction time between the TiO₂ layer and the PbO(g).

15. The method of claim 14, wherein the reaction time between the TiO₂ layer and the PbO(g) is in the range from 1 second to 60 minutes.

16. The method of claim 14, wherein the grain size of the PbTiO₃ ferroelectric thin film ranges from 1 to 5 nm.

17. The method of claim 12, wherein the TiO₂ layer is formed at a temperature of 10 to 650° C.

18. The method of claim 15, wherein the TiO₂ layer is formed at a temperature of 10 to 400° C.

19. The method of claim 11, wherein the TiO₂ layer is formed to a thickness of 1 to 100 nm.

20. The method of claim 11, wherein the formation of the TiO₂ layer is carried out by sputtering, thermal evaporation, chemical vapor deposition, metal organic chemical vapor deposition, or atomic layer deposition.

21. The method of claim 12, wherein the PbO(g) atmosphere is formed by thermal evaporation or sputtering.

22. The method of claim 12, wherein the PbO(g) atmosphere is formed by sputtering a Pb target in an oxygen atmosphere.

23. A ferroelectric recording medium manufactured by the method of claim 12.
